(19) United States
(12) Patent Application Publication
(10) Pub. No.: US 2017/0239759 A1
(43) Pub. Date: Aug. 24, 2017

(54) NICKEL-BASED SUPERALLOY WITH INCREASED OXIDATION RESISTANCE, POWDER, WELDING METHOD AND COMPONENT

(71) Applicant: SIEMENS AKTIENGESELLSCHAFT, München (DE)

(72) Inventors: TORSTEN JOKISCH, NEUENHAGEN BEI BERLIN (DE); BRITTA LAUX, BERLIN (DE)

(21) Appl. No.: 15/121,617

(22) PCT Filed: Feb. 6, 2015
(86) PCT No.: PCT/EP2015/052467

§ 371 Date: Aug. 25, 2016

(30) Foreign Application Priority Data
Mar. 11, 2014 (DE) 10 2014 204 408.1

(51) Int. Cl. B23K 35/30; B22F 1/00; B23K 31/02; C22C 19/05; B23K 35/02

(52) U.S. Cl. CPC B23K 35/304; C22C 19/056; B23K 35/0255; B23K 31/02; B22F 1/0003; B22F 2301/15

(57) ABSTRACT

A nickel-based superalloy with an increased oxidation resistance, power, and welding method, is provided. As a result of the addition of hafnium, no precipitation phases occur in the nickel-based superalloy and the proportions of chromium (Cr) and aluminium (Al) lead to a slightly reduced y′-content, thus achieving good oxidation resistance and weldability.

### CROSS-REFERENCE TO RELATED APPLICATIONS

This application claims priority to PCT Application No. PCT/EP2015/052467, having a filing date of Feb. 6, 2015, based off of DE Application No. 102014204408.1 having a filing date of Mar. 11, 2014, the entire contents of which are hereby incorporated by reference.

### FIELD OF TECHNOLOGY

The following relates to a nickel-based superalloy which has improved oxidation resistance, a powder, a welding method and a component.

### BACKGROUND

To repair the tips of turbine blades composed of γ′-strengthened nickel-based superalloys, use is generally made of welding filler materials having a composition similar to that of the base material. However, these are difficult to weld because of their high Al and Ti content, so that modified welding filler materials having improved weldability have already been developed. However, apart from the weldability, the oxidation resistance of the filler materials in the region of the blade tip is of particular interest. In this respect, the new welding filler materials do not display optimal properties up to now.

### SUMMARY

An aspect relates to a nickel-based superalloy, a powder, a method and a component in which the abovementioned problems are solved.

The example represents only part of embodiments of the invention.

It is proposed that the new welding filler materials be modified further so as to obtain improved oxidation resistance. It is desirable for a very impermeable aluminum oxide layer which passivates the material to be formed during operation. Critical elements in this respect are aluminum (Al) and chromium (Cr), and the proportion of aluminum (Al) should not be increased further with a view to weldability.

For this reason, a filler material having an increased proportion of chromium (Cr) in combination with a small proportion of hafnium (Hf) is proposed. Furthermore, a small proportion of yttrium (Y) is added to the alloy in order to improve the cyclic oxidation resistance.

The alloy contains
cobalt (Co): 8.8%-10.5%, in particular 9.5%,
chromium (Cr): 15%-17%, in particular 16%,
molybdenum (Mo): from 1.2% to 2.2%, in particular 1.7%,
tungsten (W): from 3.2% to 4.2%, in particular 3.7%,
aluminum (Al): from 2.3% to 3.3%, in particular 2.8%,
titanium (Ti): from 4.2% to 5.4%, in particular 4.8%,
boron (B): from 0.006% to 0.01%, in particular 0.008%,
zirconium (Zr): from 0.002% to 0.003%, in particular 0.025%,
hafnium (Hf): from 0.1% to 0.2%, in particular 0.15%,
carbon (C): from 0.1% to 0.2%, in particular 0.15%,
yttrium (Y): from 0.008% to 0.012%, in particular 0.01%, and
nickel, in particular nickel as balance.

A welding filler material having the following composition is preferably proposed: Ni-9.5 Co-16Cr-1.7Mo-3.7W-2.8Al-4.8Ti-0.008B-0.025Zr-0.15Hf-0.15C-0.01Y (in % by weight).

A simulation confirms that the material behaves in a manner similar to the commercial nickel-based alloy Rene 80, with a slightly reduced γ′ content being present, leading to improved weldability. As a result of the addition of hafnium (Hf), no undesirable precipitate phases are formed.

The alloy can be in the form of powder and be deposition-welded onto a component from a substrate. The substrate has a deposition weld composed of the abovementioned alloy.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A nickel-based superalloy comprising in (% by weight):
cobalt (Co): 8.8%-10.5%;
chromium (Cr): 15%-17%;
molybdenum (Mo): from 1.2% to 2.2%;
tungsten (W): from 3.2% to 4.2%;
aluminum (Al): from 2.3% to 3.3%;
titanium (Ti): from 4.2% to 5.4%;
boron (B): from 0.006% to 0.01%;
zirconium (Zr): from 0.002% to 0.003%;
hafnium (Hf): from 0.1% to 0.2%;
carbon (C): from 0.1% to 0.2%;
yttrium (Y): from 0.008% to 0.012%; and
nickel.

2. The nickel-based superalloy as claimed in claim 1, consisting of nickel (Ni), cobalt (Co), chromium (Cr), molybdenum (Mo), tungsten (W), aluminum (Al), titanium (Ti), boron (B), zirconium (Zr), hafnium (Hf), carbon (C), yttrium (Y).

3. A powder comprising an alloy as claimed in claim 1.

4. A welding method, wherein an alloy as claimed in claim 1 is used as a welding filler material.

5. The welding method as claimed in claim 4, wherein René 80 is deposition welded.

6. A component comprising
a nickel-based substrate; and
a deposition weld composed of an alloy as claimed in claim 1.

7. A welding method, wherein a powder as claimed in claim 3 is used as a welding filler material.

8. The welding method as claimed in claim 7, wherein René 80 is deposition welded.

9. A component comprising
a nickel-based substrate, and
a deposition weld composed of a powder as claimed in claim 3.
